(19) United States
(12) Patent Application Publication
(10) Pub. No.: US 2010/0017483 A1
(43) Pub. Date: Jan. 21, 2010

(54) MULTI-TOPIC INSTANT MESSAGING CHAT SESSION

(76) Inventor: Miguel A. Estrada, Hollis, NH (US)

Correspondence Address: HOFFMAN WARNICK LLC, 75 STATE STREET, 14TH FLOOR, ALBANY, NY, 12207, US

(21) Appl. No.: 12/175,550

(22) Filed: Jul. 18, 2008

(51) Int. Cl. G06F 15/16

(52) U.S. Cl. 709/206

(57) ABSTRACT

The invention provides a method, system, and program product for establishing a multi-topic instant messaging (IM) chat session. In one embodiment, the invention includes sending a first message to at least one participant or receiving a first message from at least one participant; receiving a second message from at least one participant or sending a second message to at least one participant; determining whether the first and second messages pertain to different topics; and in the case that the first and second messages pertain to different topics, splitting the IM chat session into multiple parts based on the different topics.

### TECHNICAL FIELD

The invention relates generally to instant messaging (IM) and, more particularly, to a method, system, and program product for establishing a multi-topic IM chat session.

### BACKGROUND OF THE INVENTION

Instant messaging (IM) has become a very popular method of sharing information. Typically, two or more users exchange text-based messages in real time in a back-and-forth manner, with one user often answering a question posed by or responding to a statement made by another user. IM generally works well for short, focused conversations. However, as with extended verbal conversations or conversations with many participants, its effectiveness degrades as multiple topics are discussed in parallel and become interlaced, due to the nature of asynchronous communication without cues to express context switching and throttling of the conversation. It may appear, for example, that one participant's message is non-responsive to another participant's question or statement, because the message was made in response to a question or statement on a different topic or made by a different participant. In addition, in the face of multiple topics being simultaneously discussed, a participant may forget or decide not to make an otherwise important statement, for fear of further complicating an already complicated chat session.

Accordingly, there exists a need in the art to overcome the deficiencies and limitations described hereinabove.

### SUMMARY OF THE INVENTION

The invention provides a method, system, and program product for establishing a multi-topic instant messaging (IM) chat session.

A first aspect of the invention provides a method of establishing a multi-topic instant messaging (IM) chat session, the method comprising: sending a first message to at least one participant or receiving a first message from at least one participant; receiving a second message from at least one participant or sending a second message to at least one participant; determining whether the first and second messages pertain to different topics; and in the case that the first and second messages pertain to different topics, splitting the IM chat session into multiple parts based on the different topics.

A second aspect of the invention provides a system for establishing a multi-topic instant messaging (IM) chat session, the method comprising: a system for sending a first message to at least one participant or receiving a first message from at least one participant; a system for receiving a second message from at least one participant or sending a second message to at least one participant; a system for determining whether the first and second messages pertain to different topics; and a system for splitting the IM chat session into multiple parts based on the different topics.

A third aspect of the invention provides a program product stored on a computer-readable medium, which when executed, establishes a multi-topic instant messaging (IM) chat session, the program product comprising: program code for sending a first message to at least one participant or receiving a first message from at least one participant; program code for receiving a second message from at least one participant or sending a second message to at least one participant; program code for determining whether the first and second messages pertain to different topics; and program code for splitting the IM chat session into multiple parts based on the different topics.

A fourth aspect of the invention provides a method for deploying an application for establishing a multi-topic instant messaging (IM) chat session, comprising: providing a computer infrastructure being operable to: send a first message to at least one participant or receive a first message from at least one participant; receive a second message from at least one participant or send a second message to at least one participant; determine whether the first and second messages pertain to different topics; and split the IM chat session into multiple parts based on the different topics.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-5 show diagrams of various illustrative instant messaging (IM) windows according to embodiments of the invention;

FIG. 6 shows a flow diagram of an illustrative method according to the invention; and

FIG. 7 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

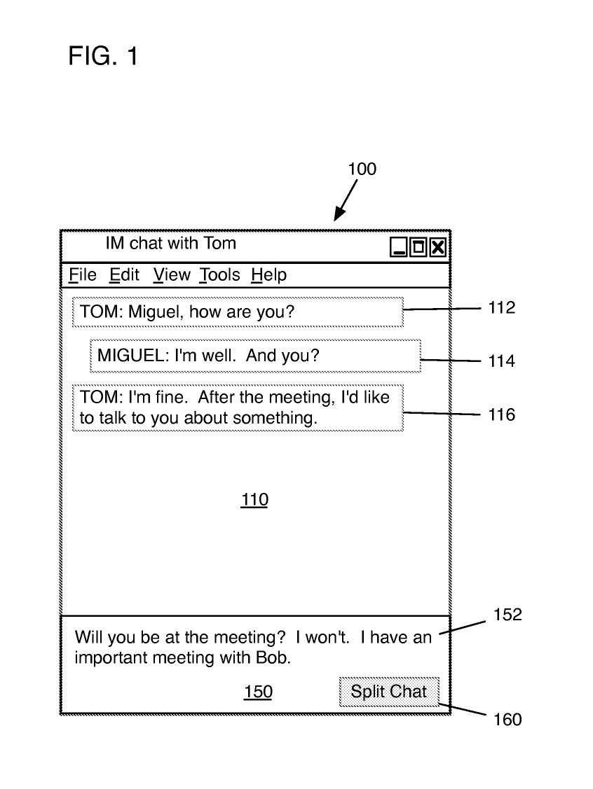

Referring now to the drawings, FIG. 1 shows an instant messaging (IM) window 100 including a transcript portion 110 and a text entry portion 150. As can be seen, the transcript portion 110 includes interactive messages 112-116, comprising an IM chat session.

Within, the text entry portion 150, a first user has entered text 152 that includes a question (“Will you be at the meeting?”) and statement (“I won't. I have an important meeting with Bob.”). However, before completing the entry and adding it to the transcript portion 110, a second user has sent a message 116 that both makes the first user's question unnecessary (“After the meeting, . . . ”) and raises a new issue or topic (“I'd like to talk to you about something.”). To date, such a situation has required the first user to either delete the entered text 152 or add it to the chat session. The former solution necessitates wasted time and effort on the part of the first user and presents the possibility that other information in the entered text 152 will not be re-entered later in the chat session. The latter solution may introduce confusion into the chat session, likely requiring explanation and duplication of efforts on the part of both the first and second user.

IM window 100 therefore includes a Split Chat button 160, which enables a user to divide the chat session according to the topics being discussed. While shown as a button, it should be recognized that any number of alternative methods may be used to divide the chat session, such as a keystroke or the selection of a menu item. Split Chat button 160 is shown merely for purposes of illustration.

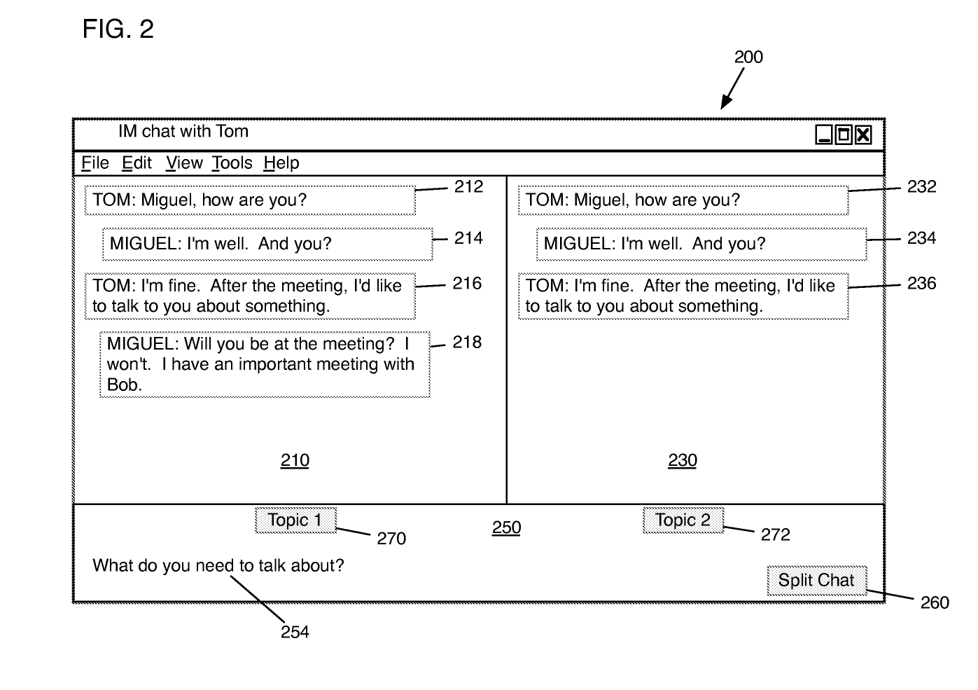

In FIG. 2, the Split Chat button 160 (FIG. 1) has been clicked, thereby dividing the transcript portion 110 (FIG. 1) of IM window 200 in two 210, 230. Messages within the transcript portion 110 prior to clicking the Split Chat button 160 are duplicated in each transcript portion 210, 230. However, from this point forward, messages may be selectively added to either transcript portion 210, 230, based on the topic contained within each. For example, the first user has chosen to enter the entered text 152 into transcript portion 210, relating to meeting attendance. Meanwhile, the first user has also entered text 254 within the text entry portion 250 that relates to the topic being discussed in transcript portion 230. As shown in FIG. 2, the text entry portion 250 includes Topic 1 and Topic 2 buttons 270, 272, which permit a user to select which transcript portion to which the entered text 254 will be added. Here, the first user would click the Topic 2 button 272 to add the entered text 254 to transcript portion 230. Alternatively, IM window 200 may include a divided the text entry portion 250, such that a user may enter text in the particular division of the text entry portion corresponding to the transcript portion to which the entered text relates. In FIG. 2, the text entry portion 250 includes a Split Chat button 260, which permits further division of the transcript portion 210, 230 and, optionally, the text entry portion 250, in the event that distinct issues are raised within either transcript portion 210, 230 that a user wishes to pursue separately.

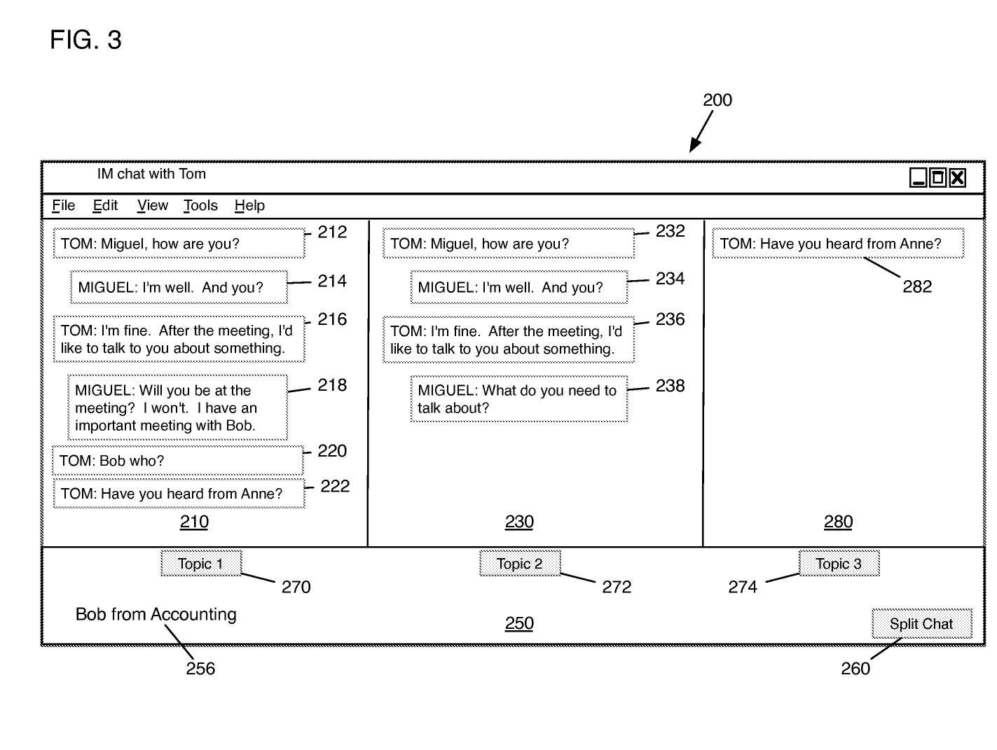

For example, FIG. 3 shows a further division of the transcript portion 210, 230, 280 of IM window 200. Here, a user has added a message 220 to transcript portion 210 that relates to a different topic than that previously being pursued in transcript portion 210. By clicking the Split Chat button 260, a third transcript portion 280 is established, in which the new topic may be pursued. In addition, the first user has entered text 256 in the text entry portion 250 responding to the second user's message 220 within transcript portion 210.

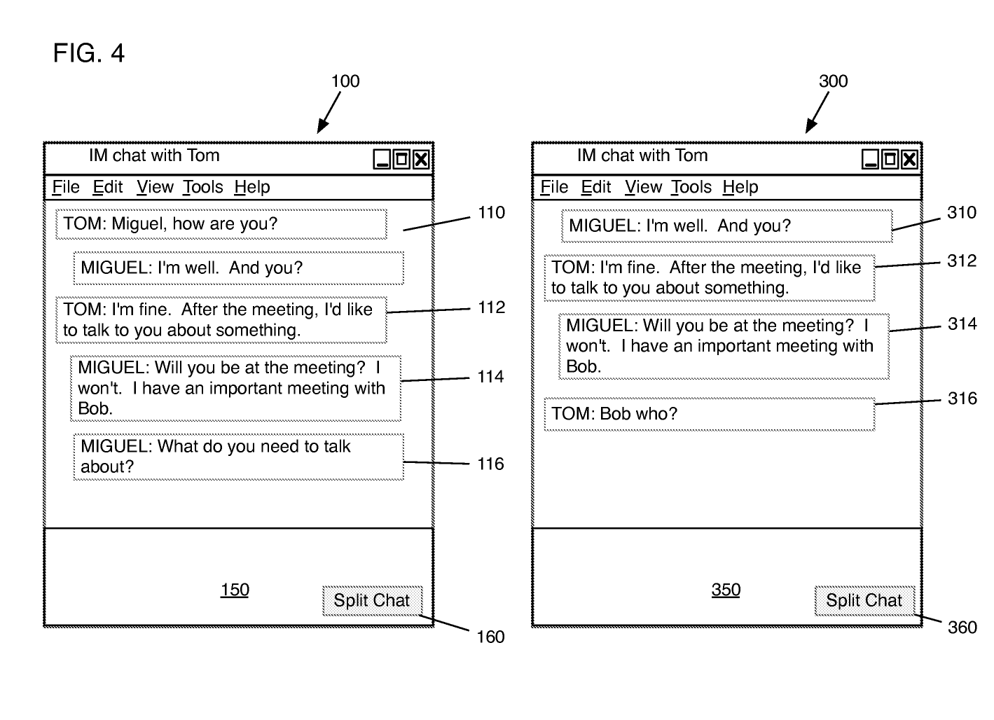

FIG. 4 shows an alternative embodiment of the invention, wherein clicking the Split Chat button 160 divides the IM window 100 itself, thereby creating a second IM window 300 in which a separate topic may be pursued. Further division of either IM window 100, 300 may be accomplished as described above, by clicking the relevant Split Chat button 160, 360. Similarly, text may be entered in either text entry portion 150, 350, depending on the topic to which the entered text pertains.

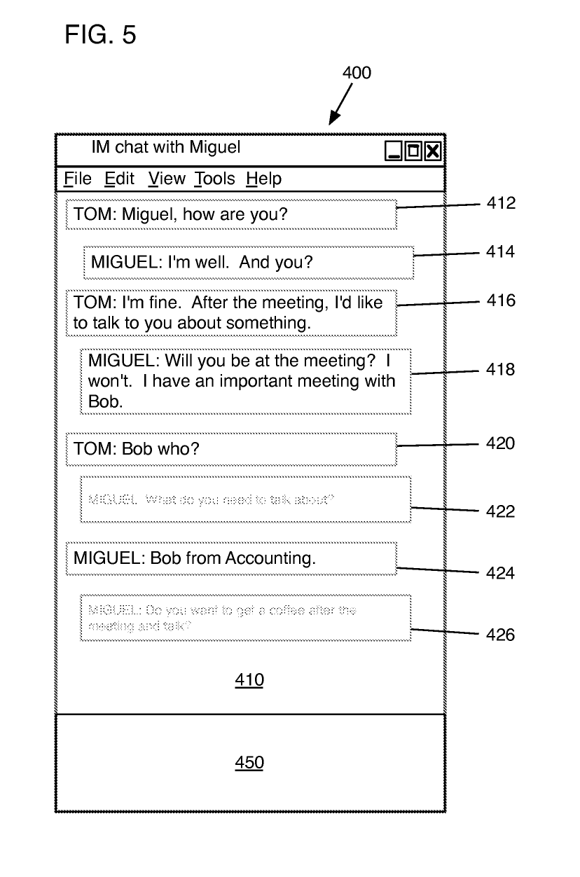

In an alternative embodiment, wherein the second user is not using an IM program that supports the splitting of the chat session, messages pertaining to different topics may be displayed within the same IM window, but distinguished. Such an embodiment is shown in FIG. 5, wherein some messages 412-420, 424 are shown in a first typeface to distinguish them as pertaining to one topic. Other messages 422, 426 are shown in a second typeface to distinguish them as pertaining to another topic. Any splitting of a chat session may be employed by any user participating in the chat session. For example, one user may employ split transcript portions as shown in FIGS. 2-3 while another user may split the chat session as in FIG. 4 or in FIG. 5. Regardless, the messages within the chat session are the same and each user may participate as fully as any other user employing a different method of splitting the chat session.

While described above and shown in the figures as involving the splitting of a chat session into two distinct topics, it should be recognized that the invention includes the splitting of a chat session into any number of topics. Similarly, a chat session may involve any number of participants, with the chat session being split into any number of topics among the participants. For example, a chat session may include four participants engaging in messaging on five topics. Some participants may be engaged in only one of the five topics while others are engaged in all five. The IM windows of a particular participant, therefore, will be split or modified to show the number of topics in which the participant is engaged.

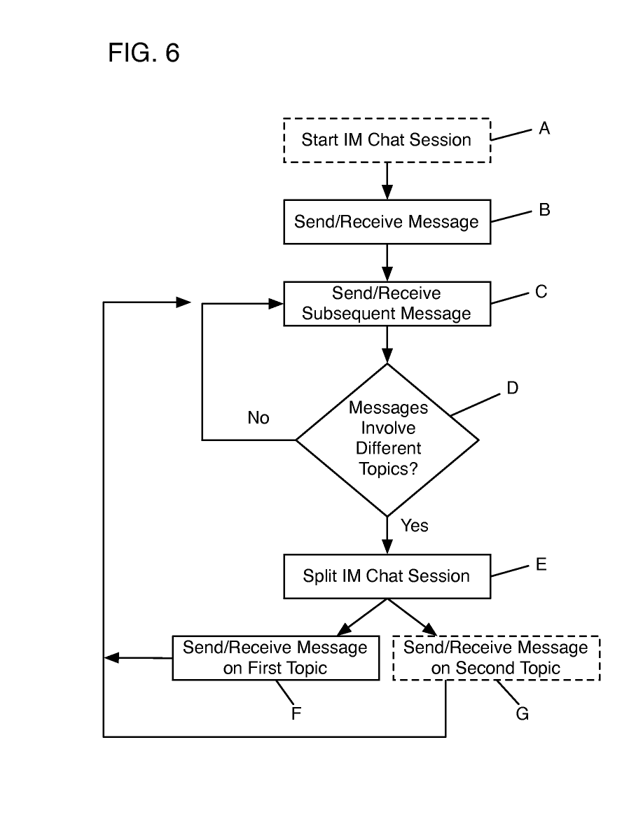

FIG. 6 shows a flow diagram of an illustrative method according to the invention. At A, a user starts an IM chat session, if one has not already been started by a second user. At B, the first user sends or receives a message (e.g., the first user may start the IM chat session by sending a message or may receive a message from a second user who has thereby started the IM chat session). At C, a subsequent message is sent or received by the first user.

At D, it is determined whether the messages sent or received at B and C pertain to different topics. If so (i.e., Yes at D), the first user splits the IM chat session at E. If not (i.e., No at D), the first user awaits a subsequent message and C and D are iteratively looped.

At F, a message pertaining to a first topic is sent or received, after which C through F may be iteratively looped to determine whether the IM chat session should be further split. Optionally, a message pertaining to the second topic may be sent or received, after which C through F or C through E and G may be iteratively looped.

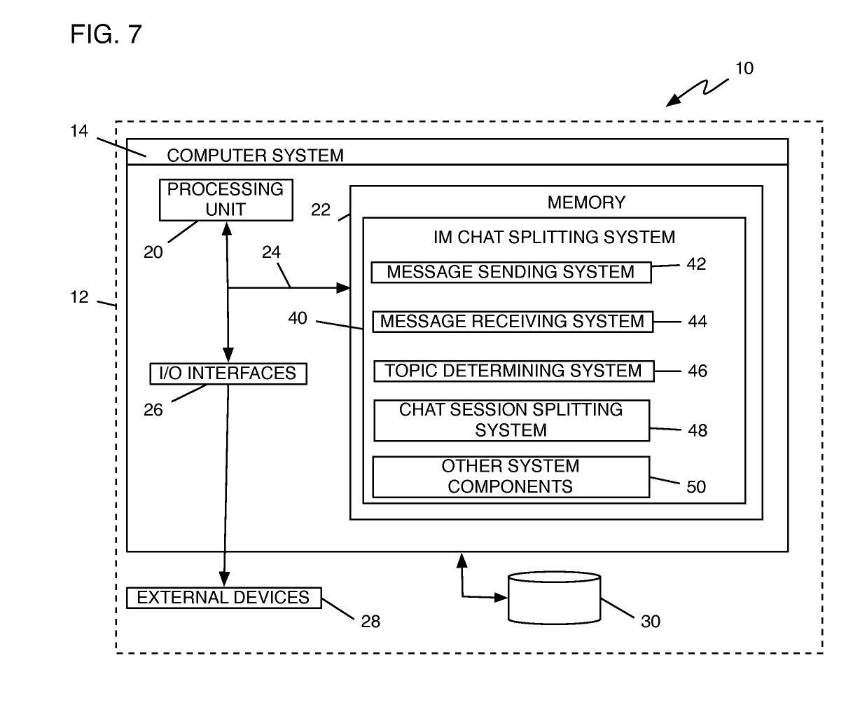

FIG. 7 shows an illustrative system 10 for splitting an IM chat session. To this extent, system 10 includes a computer infrastructure 12 that can perform the various process steps described herein for splitting an IM chat session. In particular, computer infrastructure 12 is shown including a computer system 14 that comprises an IM chat splitting system 40, which enables computer system 14 to split an IM chat session by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as boundary identification system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and boundary identification system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, IM chat splitting system 40 enables computer system 14 to split an IM chat session. To this extent, IM chat splitting system 40 is shown including a message sending system 42, a message receiving system 44, a topic determining system 46, and a chat session splitting system 48. Operation of each of these systems is discussed above. IM chat splitting system 40 may further include other system components 50 to provide additional or improved functionality to boundary identification system 40. It is understood that some of the various systems shown in FIG. 7 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for splitting an IM chat session, it is understood that the invention further provides various alternative embodiments. For example, in one embodiment, the invention provides a computer-readable medium that includes computer program code to enable a computer infrastructure to split an IM chat session. To this extent, the computer-readable medium includes program code, such as IM chat splitting system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to split an IM chat session, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for splitting an IM chat session. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of establishing a multi-topic instant messaging (IM) chat session, the method comprising:
sending a first message to at least one participant or receiving a first message from at least one participant;
receiving a second message from at least one participant or sending a second message to at least one participant;
determining whether the first and second messages pertain to different topics; and
in the case that the first and second messages pertain to different topics, splitting the IM chat session into multiple parts based on the different topics.

2. The method of claim 1, further comprising:
sending a third message pertaining to a first topic.

3. The method of claim 1, further comprising:
receiving a third message pertaining to a first topic.

4. The method of claim 1, wherein splitting the IM chat session includes splitting an IM window into multiple windows.

5. The method of claim 1, wherein splitting the IM chat session includes distinguishing the first and second messages within a single IM window.

6. The method of claim 5, wherein distinguishing the first and second messages includes displaying the first and second messages using different typefaces.

7. The method of claim 5, wherein distinguishing the first and second messages includes displaying the first and second messages in different areas of the single IM window.

8. The method of claim 1, wherein splitting the IM chat session includes splitting an IM window of a first participant into multiple windows and distinguishing the first and second messages within a single IM window of a second participant.

9. A system for establishing a multi-topic instant messaging (IM) chat session, the method comprising:
a system for sending a first message to at least one participant or receiving a first message from at least one participant;
a system for receiving a second message from at least one participant or sending a second message to at least one participant;
a system for determining whether the first and second messages pertain to different topics; and
a system for splitting the IM chat session into multiple parts based on the different topics.

10. The system of claim 9, further comprising:
a system for sending a third message pertaining to a first topic.

11. The system of claim 9, further comprising:
a system for receiving a third message pertaining to a first topic.

12. The system of claim 9, wherein the system for splitting the IM chat session includes a system for splitting an IM window into multiple windows.

13. The system of claim 9, wherein the system for splitting the IM chat session includes a system for distinguishing the first and second messages within a single IM window.

14. The system of claim 13, wherein the system for distinguishing the first and second messages includes a system for displaying the first and second messages using different typefaces.

15. The system of claim 13, wherein the system for distinguishing the first and second messages includes a system for displaying the first and second messages in different areas of the single IM window.

16. The system of claim 9, wherein the system for splitting the IM chat session includes a system for splitting an IM window of a first participant into multiple windows and a system for distinguishing the first and second messages within a single IM window of a second participant.

17. A program product stored on a computer-readable medium, which when executed, establishes a multi-topic instant messaging (IM) chat session, the program product comprising:
program code for sending a first message to at least one participant or receiving a first message from at least one participant;
program code for receiving a second message from at least one participant or sending a second message to at least one participant;
program code for determining whether the first and second messages pertain to different topics; and
program code for splitting the IM chat session into multiple parts based on the different topics.

18. The program product of claim 17, further comprising:
program code for splitting an IM window into multiple windows.

19. The program product of claim 17, further comprising:
program code for displaying the first and second messages in different areas of a single IM window.

20. The program product of claim 17, further comprising:
program code for splitting an IM window of a first participant into multiple windows; and
program code for distinguishing the first and second messages within a single IM window of a second participant.

21. A method for deploying an application for establishing a multi-topic instant messaging (IM) chat session, comprising:
providing a computer infrastructure being operable to:
send a first message to at least one participant or receive a first message from at least one participant;
receive a second message from at least one participant or send a second message to at least one participant;
determine whether the first and second messages pertain to different topics; and
split the IM chat session into multiple parts based on the different topics.
